(19) United States
(12) Patent Application Publication
(10) Pub. No.: US 2006/0268979 A1
(43) Pub. Date: Nov. 30, 2006

(54) Wireless monitoring camera device

(76) Inventor: Myung Hyun Chang, Cheongju (KR)

Correspondence Address: PARK LAW FIRM, 3255 WILSHIRE BLVD, SUITE 1110, LOS ANGELES, CA, 90010, US

(21) Appl. No.: 11/227,056

(22) Filed: Sep. 15, 2005

(30) Foreign Application Priority Data
May 25, 2005 (KR) 10-2005-0044126

(51) Int. Cl. H04N 11/04; H04N 11/02; H04N 7/12; H04B 1/66

(52) U.S. Cl. 375/240.01

(57) ABSTRACT

A wireless monitoring camera device includes a CMOS image sensor adapted to receive a video signal through photographing, a video signal processor adapted to convert the video signal received from the image sensor into a JPEG or MPEG file, a transmit unit adapted to transmit the converted video signal received from the video signal processor to a receive unit connected to an external storage unit in a wireless manner, a power supply unit adapted to supply driving power to the image sensor, the video signal processor and the transmit unit, a solar cell adapted to receive light emitted output from the sun or a lighting to generate photoelectromotive force x, and a power supply controller adapted to convert the photoelectromotive force generated from the solar cell so that the photoelectromotive force can be used as driving power by the power supply unit.

### BACKGROUND OF THE INVENTION

1. Field of the Invention

The present invention relates to a wireless monitoring camera device, and more particularly, to an improved wireless monitoring camera device which can operate without additional external power supply and transmit an image in a wireless manner when receiving an image using power itself at places where the supply of power is difficult and its installation is complicated, such as vehicles or buildings.

2. Background of the Related Art

Generally, monitoring camera devices are installed at the inside and outside of offices, houses, hospitals, banks, pubic buildings for which security is needed, etc. and are widely used for entrance and exit control or crime prevention. Recently, there has been proposed a vehicle buglarproof system using a camera, which can trace a theft vehicle using a monitoring camera device and a sensor to arrest a suspect and prevent the theft of a vehicle.

Most of the monitoring camera device is installed at places where a man's hands do not reach, such as the surface of a wall or the ceiling.

The monitoring camera device can be mainly classified into a dome type, a set type, a bullet type, a miniature type and the like according to an installation type. Among them, the dome type and the set type are used widely since they well suit indoor decoration.

FIG. 1 is a view showing an external form and an installation state of a dome type monitoring camera according to the prior art.

FIG. 2 is a view showing an external form and an installation state of a set type monitoring camera according to the prior art.

Referring to FIG. 1, the dome type monitoring camera includes a base 110 having a male screw installed on its circumference, a camera module 120 whose angle can be controlled, for acquiring a video signal, an opaque hemispherical cover 130 having a window through which the camera module 110 is exposed, and a ring-shaped dome body 140 that fixes the cover 130 and is screwed to the base 110, wherein the ring-shaped dome body has a female screw formed on its circumference. In this case, the ring-shaped dome body 140 is fixed to the surface of a wall or the ceiling of a structure by means of a bracket.

At this time, a power supply cable 150 that supplies driving power to the camera module 120 and a video cable 160 that transmits an image picked up in the camera module 120 are fixed to an installation surface of a wall.

Referring to FIG. 2, the set type monitoring camera includes a lens unit 115, a body unit 125 having a camera module, and a cover 135. The set type monitoring camera is fixed to the surface of a wall or the ceiling of a structure by means of a bracket 145. Even in this case, a power supply cable 155 that supplies driving power to the camera module and a video cable 165 that transmits an image picked up in the camera module are connected to the rear of the body unit 125.

In the monitoring camera device according to the prior art, however, the power supply cables 150 and 155 and the video cables 160 and 165 are provided in a wired manner. This makes installation work complicated, thus limiting an installation place and space. Further, there is a problem in that a fine view around a place where the device is installed is damaged due to the wired cable.

Furthermore, in the case where the power supply cables 150 and 155 are cut in advance by means of an invader, the driving power is not supplied to the camera module. Thus, there is a problem in that a normal operation cannot be performed. If the video cables 160 and 165 are cut, an image picked up in the camera module is not transmitted. Accordingly, there is a problem in that an image is not stored in an additional storage unit.

### SUMMARY OF THE INVENTION

The present invention provides a wireless monitoring camera device, which can be easily installed at places where connection of wired cables is difficult in such a way that pick-up images are transmitted to a storage unit located at a predetermined distance in a wireless way.

Further, the present invention provides a wireless monitoring camera device, which can be easily installed at places where the supply of power is difficult using a common battery and a solar cell as driving power, thus enabling a long-time operation without the supply of external power, and can prevent the supply of power fro being stopped by an invader.

According to an aspect of the present invention, there is provided a wireless monitoring camera device, including a CMOS image sensor adapted to receive a video signal through photographing; a video signal processor adapted to convert the video signal received from the image sensor into a JPEG or MPEG file; a transmit unit adapted to transmit the converted video signal received from the video signal processor to a receive unit connected to an external storage unit in a wireless manner; and a power supply unit adapted to supply driving power to the image sensor, the video signal processor and the transmit unit.

The wireless monitoring camera device further includes a solar cell adapted to receive light emitted from the sun or lighting to generate photoelectromotive force, and a power supply controller adapted to convert the photoelectromotive force generated from the solar cell so that the photoelectromotive force can be used as driving power by the power supply unit.

The transmit unit includes a wireless system on a chip, and transmits the video signal using an Ultra Wide Band (UWB) wireless technology.

### BRIEF DESCRIPTION OF THE DRAWINGS

Further objects and advantages of the invention can be more fully understood from the following detailed description taken in conjunction with the accompanying drawings in which:

FIG. 1 is a view showing an external form and an installation state of a dome type monitoring camera according to the prior art;

FIG. 2 is a view showing an external form and an installation state of a set type monitoring camera according to the prior art; and

FIG. 3 is a block diagram showing the construction of a wireless monitoring camera device according to an embodiment of the present invention.

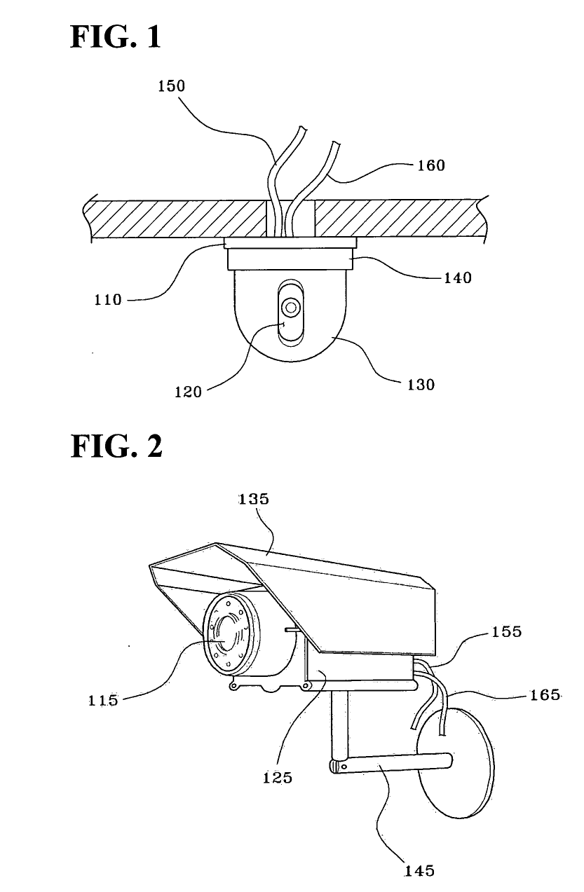

### DETAILED DESCRIPTION OF THE PREFERRED EMBODIMENT

The present invention will now be described in detail in connection with preferred embodiments with reference to the accompanying drawings.

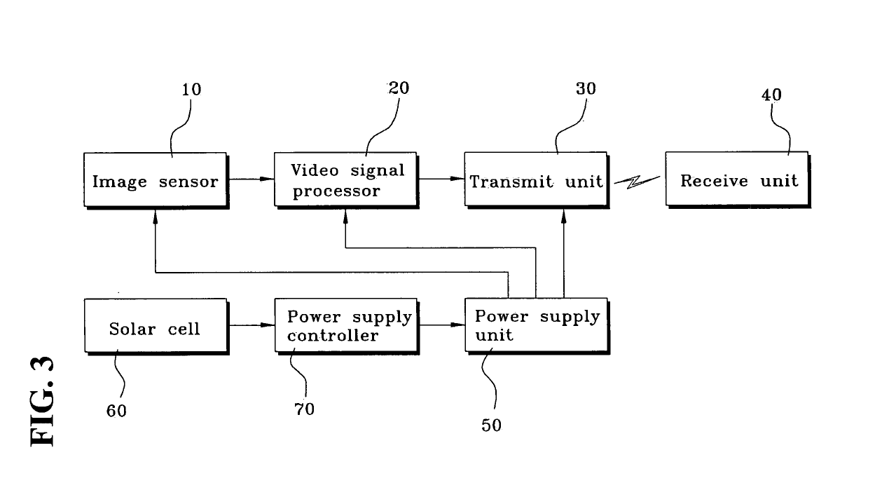

FIG. 3 is a block diagram showing the construction of a wireless monitoring camera device according to an embodiment of the present invention.

In FIG. 3, reference numeral 10 indicates an image sensor that receives a video signal through photographing. The image sensor includes a lens module, and can preferably employ a CMOS image sensor. It is to be understood that the image sensor 10 can be constructed using a well-known CCD (Charge Coupled Device) module.

Furthermore, reference numeral 20 indicates a video signal processor that modulates a video signal received from the image sensor 10. The video signal processor 20 converts an input image into a JPEG or MPEG file.

Furthermore, reference numeral 30 indicates a transmit unit that transmits a video signal modulated in the video signal processor 20 in a wireless manner. It can consist of a wireless system on a chip. At this time, the video signal processor 20 and the transmit unit 30 preferably consist of a single chip. Furthermore, the transmit unit 30 transmits a video signal in a frequency of 2.4 GHz at a band of 20 MHz to 1 GHz based on an Ultra Wide Band (UWB) wireless technology. The UWB wireless technology applied at this time includes devices that support various distances according to needs, and has the capacity of exchanging information within a radius of 15 to 20 meters. The UWB wireless technology can be shared without interference with frequency bands that have been used, and it is advantageous in that it can have a wide-band frequency band ranging several hundreds of Mbps. Further, the UWB wireless technology has a characteristics that it has lower power consumption of about ¼ of Bluetooth technology and it can penetrate the wall and ground.

Furthermore, reference numeral 40 indicates a receive unit connected to a storage unit, for receiving a video signal output from the transmit unit 30 in a wireless manner. At this time, the receive unit 40 can modulate the video signal into an analog signal or a digital signal. The video signal can be output in NTSC (National Television System Committee) mode or PAL (Phase Alternation by Line) mode depending upon a display apparatus.

Furthermore, reference numeral 50 indicates a power supply unit that supplies driving power to the image sensor 10, the video signal processor 20 and the transmit unit 30. The power supply unit 50 can employ a variety of types such as a common battery or a rechargeable battery.

Furthermore, reference numeral 60 indicates a solar cell that receives light generated from a sun or lighting to generate photoelectromotive force. Reference numeral 70 indicates a power supply controller that controls photoelectromotive force generated from the solar cell 60 to be used in the power supply unit 50 as driving power. The use of the solar cell 60 can prevent frequent exchange, cost increase, and the stop of functions of a camera due to discharge of a battery.

In order for the present system to operate without external supply of power, the applicant of the present invention tried to design the system having minimum consumption power. Thus, the system is designed to have consumption current of overall 3 μA to 10 MA.

To this end, the present invention includes a microcomputer (not shown) that controls the entire operation of the system. The system can further include a sensor (not shown) that generates an operation start signal such that the system does not continue operating, but operates only when it is necessary to acquire a video signal. In this case, the sensor that generates the operation start signal can employ a superconducting sensor that senses infrared rays generated from the human body in a non-contact manner.

The operation of the wireless monitoring camera device constructed above according to the present invention will be described in short.

The image sensor 10 converts a light signal received through the lens module into an electrical signal. The video signal processor 20 then converts the signal into a digital signal as a video signal of a predetermined format such as a JPEG or MPEG file.

The video signal modulated in the video signal processor 20 is transmitted through the transmit unit 30 in a wireless manner. The receive unit 40 then modulates the video signal, and outputs the modulated signal as an analog signal or a digital signal. Thus, the signal is displayed or stored in a storage unit.

While the operation is performed, the power supply unit 50 supplies driving power. Photoelectromotive force generated in the solar cell 60 is converted through the power supply controller 70 so that it can be used as driving power in the power supply unit 50.

Meanwhile, in the present invention, only when the sensor that generates the operation start signal senses the human body, the system operates to acquire a video signal.

As described above, in accordance with a wireless monitoring camera device according to the present invention, a pick-up image is wirelessly transmitted to a storage unit located at a predetermined distance. Thus, there is an advantageous effect in that the wireless monitoring camera device can be easily installed even at places where connection of wired cables is difficult.

Furthermore, power cords are not necessary since a common battery and a solar cell are used as a driving power supply. This facilitates the installation of a wireless monitoring camera device at places where the supply of power is difficult. Accordingly, there are effects in that installation is easy and simple, and a case where a wireless monitoring camera device does not operate due to the stop of the supply of power by an invader can be prevented.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

What is claimed is:

1. A wireless monitoring camera device, comprising:
a CMOS image sensor adapted to receive a video signal through photographing;
a video signal processor adapted to convert the video signal received from the image sensor into a JPEG or MPEG file;
a transmit unit adapted to transmit the converted video signal received from the video signal processor to a receive unit connected to an external storage unit in a wireless manner; and
a power supply unit adapted to supply driving power to the image sensor, the video signal processor and the transmit unit.

2. The wireless monitoring camera device as claimed in claim 1, further including:
a solar cell adapted to receive light emitted output from the sun or a lighting to generate photoelectromotive force; and
a power supply controller adapted to convert the photoelectromotive force generated from the solar cell so that the photoelectromotive force can be used as driving power by the power supply unit.

3. The wireless monitoring camera device as claimed in claim 1, wherein the transmit unit includes a wireless system on a chip, and transmits the video signal using an Ultra Wide Band (UWB) wireless technology.
